(19) United States
(12) Patent Application Publication
(10) Pub. No.: US 2009/0032753 A1
(43) Pub. Date: Feb. 5, 2009

(54) LINEAR SOLENOID

(75) Inventors: Ryo ISHIBASHI, Kariya-city (JP); Motoyoshi Ando, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/184,899

(22) Filed: Aug. 1, 2008

(30) Foreign Application Priority Data
Aug. 2, 2007 (JP) 2007-202098

(51) Int. Cl. F16K 31/02

(52) U.S. Cl. 251/129.15

(57) ABSTRACT

A plunger is axially intersectable with a tubular recessed portion formed in a magnetically attracting core of a stator core upon slide movement of the plunger, which places a predetermined portion of the plunger into the tubular recessed portion. A magnetic material in the predetermined portion of the plunger may have a predetermined outer diameter that is smaller than an outer diameter of the magnetic material in a slidably contacting portion of the plunger, which slidably contacts a slidable core of the stator core. Alternatively, a magnetic material in the tubular recessed portion may have a predetermined inner diameter that is larger than an inner diameter of the magnetic material in a slidably contacting portion of the slidable core, which slidably contacts the plunger.

### CROSS REFERENCE TO RELATED APPLICATION

This application is based on and incorporates herein by reference Japanese Patent Application No. 2007-202098 filed on Aug. 2, 2007.

### BACKGROUND OF THE INVENTION

1. Field of the Invention

The present invention relates to a linear solenoid.

2. Description of Related Art

FIG. 3 shows a previously proposed linear solenoid of a solenoid hydraulic pressure control valve, in which a plunger directly slides along an inner peripheral surface of a stator core. Here, it should be noted that FIG. 3 is provided for purpose of illustrating technical background of the present invention and should not be considered as a prior art.

The solenoid hydraulic pressure control valve of FIG. 3 includes a spool valve 1 and the linear solenoid 2. The linear solenoid 2 drives the spool valve 1.

The linear solenoid 2 includes a coil 13, a plunger 14 and a magnetic stator 15. Here, the magnetic stator 15 is a component of a magnetic circuit and includes a magnetic yoke 17 and a stator core 21. The yoke 17 is configured into a cup-shaped body, which covers an outer peripheral surface of the coil 13.

The stator core 21 includes a magnetically attracting core 18, a slidable core 20 and a magnetically insulating portion 19, which are formed integrally. The magnetically attracting core 18 magnetically axially attracts the plunger 14. The slidable core 20 is configured into a cup-shaped body, which covers an outer peripheral surface of the plunger 14 such that the plunger 14 directly slides along an inner peripheral surface of the slidable core 20. The magnetically insulating portion 19 magnetically insulates between the magnetic attracting core 18 and the slidable core 20.

The plunger 14 is axially driven by changing the current value of the electric current supplied to the coil 13, so that the spool 4 of the spool valve 1 is axially displaced.

Japanese Unexamined Patent Publication No. 2006-307984 (corresponding to US 2006/0243938A1) teaches a technique, which is similar to the above described technique.

In the case of the linear solenoid 2 of FIG. 3, in which the plunger 14 directly slides along the inner peripheral surface of the stator core 21, a radial slide gap (slide clearance) is present between the plunger 14 and the stator core 21. The slide gap is provided to axially slidably supports the plunger 14 by the inner peripheral surface of the stator core 21. An installation gap for absorbing product-to-product manufacturing variations of the plunger 14 and of the stator core 21 is added to this slide gap.

Due to the presence of the radial slide gap between the plunger 14 and the stator core 21, a center axis of the plunger 14 tends to deviate in the radial direction from the center axis of the stator core 21 due to the application of the gravitational force and vibrations, as shown in FIG. 9A. In this state, when the plunger 14 is magnetically attracted to the stator core 21 upon the energization of the coil 13, a magnetic flux is biased at the time of passing between the plunger 14 and the stator 21 in the radial direction. When such biasing of the magnetic flux occurs, a radial side force (hereinafter, referred to as a radial side force α) is generated on the plunger 14 in the biasing direction of the magnetic flux to interfere with the smooth slide movement between the plunger 14 and the stator core 21.

At a location where the plunger 14 and the stator core 21 directly contact with each other, the magnetic flux is concentrated and is thereby biased. Thus, in order to limit the concentration and biasing of the magnetic flux, a non-magnetic layer (e.g., nickel zinc plating), may be formed on the slidable surface of the plunger 14 (at least one of the outer peripheral surface of the plunger 14 and the inner peripheral surface of the stator core 21) to alleviate the concentration of the magnetic flux caused by the contact and thereby to reduce the radial side force α, as shown in FIG. 9B. However, when the non-magnetic layer 14c is additionally formed on the slidable surface of the plunger 14, the manufacturing costs are disadvantageously increased.

Furthermore, even when the non-magnetic layer 14c is formed on the slidable surface of the plunger 14, the relatively large radial side force α of the plunger 14 is still generated at the magnetically attracting portion. Thus, even in the case where the non-magnetic layer 14c is formed on the slidable surface of the plunger 14, it has been demanded to further reduce the radial side force α.

### SUMMARY OF THE INVENTION

The present invention addresses at least one of the above disadvantages.

According to one aspect of the present invention, there is provided a linear solenoid, which includes a stator core and a plunger. The stator core is made of a magnetic material and includes a magnetically attracting core, a magnetically insulating portion and a slidable core, which are formed integrally. The plunger is made of a magnetic material and is directly slidable along an inner peripheral surface of the slidable core. A tubular recessed portion is formed in the magnetically attracting core. The plunger is axially intersectable with the tubular recessed portion upon slide movement of the plunger, which places a predetermined portion of the plunger into the tubular recessed portion. The magnetic material in the predetermined portion of the plunger has a predetermined outer diameter that is smaller than an outer diameter of the magnetic material in a slidably contacting portion of the plunger, which slidably contacts the slidable core.

According to another aspect of the present invention, there is provided a linear solenoid, which includes a stator core and a plunger. The stator core is made of a magnetic material and includes a magnetically attracting core, a magnetically insulating portion and a slidable core, which are formed integrally. The plunger is made of a magnetic material and is directly slidable along an inner peripheral surface of the slidable core. A tubular recessed portion is formed in the magnetically attracting core. The plunger is axially intersectable with the tubular recessed portion upon slide movement of the plunger, which places a predetermined portion of the plunger into the tubular recessed portion. The magnetic material in the tubular recessed portion has a predetermined inner diameter that is larger than an inner diameter of the magnetic material in a slidably contacting portion of the slidable core, which slidably contacts the plunger.

### BRIEF DESCRIPTION OF THE DRAWINGS

The invention, together with additional objectives, features and advantages thereof, will be best understood from the following description, the appended claims and the accompanying drawings in which:

FIG. 1A is a longitudinal cross sectional view of a solenoid hydraulic pressure control valve according to a first embodiment of the present invention;

FIG. 1B is an enlarged partial view of a portion of FIG. 1A;

FIG. 2 is a cross sectional view of a tubular recessed portion in a magnetically attracting core of a linear solenoid of the solenoid hydraulic pressure control valve according to the first embodiment;

FIG. 3 is a longitudinal cross sectional view of a previously proposed solenoid hydraulic pressure control valve;

FIG. 4A is a longitudinal cross sectional view of the previously proposed solenoid hydraulic pressure control valve of FIG. 3, illustrating a disadvantage associated thereto;

FIG. 4B is a partial enlarged view showing a portion of FIG. 4A;

FIG. 5 is a cross sectional view of a tubular recessed portion in a magnetically attracting core of a linear solenoid of a solenoid hydraulic pressure control valve according to a second embodiment of the present invention;

FIG. 6A is an enlarged partial longitudinal cross sectional view of a solenoid hydraulic pressure control valve according to a third embodiment of the present invention;

FIG. 6B is an enlarged partial cross sectional view showing a tubular recessed portion in a magnetically attracting core of a linear solenoid of the solenoid hydraulic pressure control valve of FIG. 6A;

FIG. 7 is a cross sectional view of a tubular recessed portion in a magnetically attracting core of a linear solenoid of a solenoid hydraulic pressure control valve according to a fourth embodiment of the present invention;

FIG. 8 is a longitudinal cross sectional view of a solenoid hydraulic pressure control valve according to a fifth embodiment of the present invention;

FIG. 9A is a cross sectional view of a tubular recessed portion in a magnetically attracting core of a linear solenoid of a previously proposed solenoid hydraulic pressure control valve; and

FIG. 9B is a cross sectional view of a tubular recessed portion in a magnetically attracting core of a linear solenoid of another previously proposed solenoid hydraulic pressure control valve.

### DETAILED DESCRIPTION OF THE INVENTION

### First Embodiment

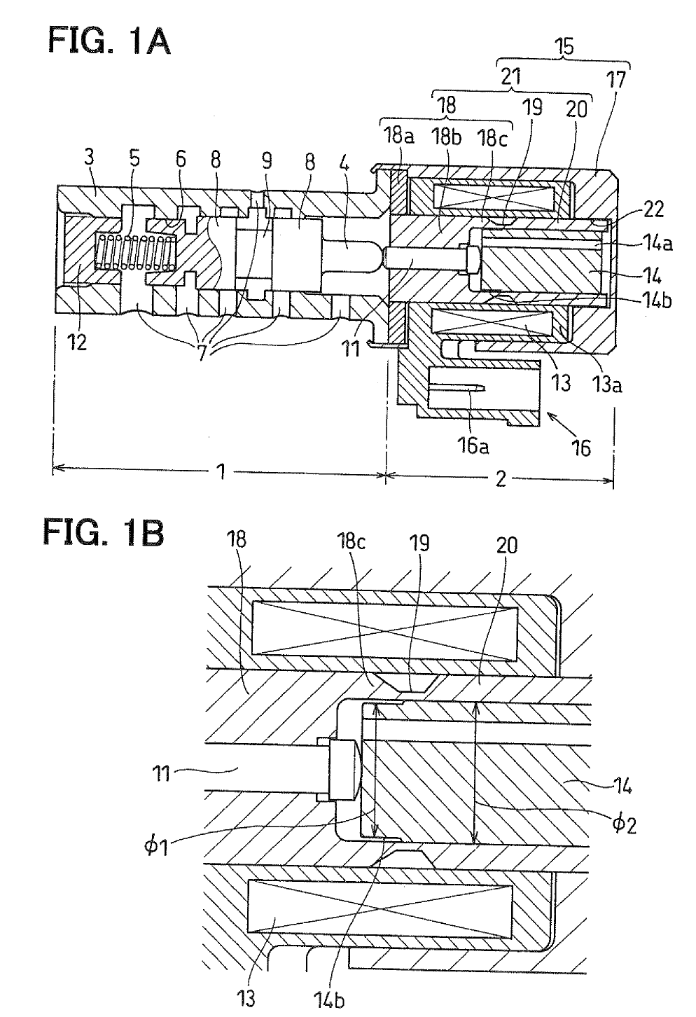

A first embodiment of the present invention will be described with reference to FIGS. 1A to 4B. In the first embodiment, a structure of a comparative hydraulic pressure control valve will described in general. Then, a background of the first embodiment will be described, and thereafter the characteristics of the first embodiment will be described. In the following description, for the illustrative purpose, the left side of FIGS. 1A-1B, 3 and 4A-4B will be referred to as a left side, and the right side of FIGS. 1A-1B, 3 and 4A-4B will be referred to as a right side. However, these terms are not related to the actual installation direction The structure of the comparative solenoid hydraulic pressure control valve will be described with reference to FIG. 3.

The solenoid hydraulic pressure control valve of the first embodiment is installed in, for example, a hydraulic pressure control device of an automatic transmission. Specifically, the solenoid hydraulic pressure control valve of the first embodiment is placed in oil in an interior of a case of a hydraulic pressure controller, which is fluid tightly sealed from the outside. The solenoid hydraulic pressure control valve includes a spool valve 1 and a linear solenoid 2. The linear solenoid 2 drives the spool valve 1.

The spool valve 1 includes a sleeve 3, a spool 4, and a spring 5 (return spring).

The sleeve 3 is configured into a generally cylindrical body and has a receiving hole 6, which extends along a center axis of the sleeve 3 to axially slidably receive the spool 4 therein. Furthermore radial oil ports 7 are formed in the sleeve 3.

The oil ports 7 include an input port, an output port, a discharge port and drain ports. The input port is communicated with an oil discharge outlet of an oil pump (not shown) and receives an input pressure from the oil pump. The output pressure, which is adjusted by the solenoid hydraulic pressure control valve, is outputted through the outlet port. The discharge port is communicated with the low pressure side. The drain ports are provided to enable breathing through the drain ports.

The spool 4 is slidably received in the sleeve 3 and is driven to change a size of an opening of each corresponding one of the oil ports 7 and thereby to change the communication state of each corresponding one of the oil ports 7. The spool 4 includes a plurality of lands 8, which can close the oil ports 7, and a small diameter portion 9, which is provided between the lands 8.

A linear solenoid 2 side end portion of the spool 4 is in contact with a shaft 11, which extends into an interior of the linear solenoid 2. A distal end of the shaft 11 is in contact with an end surface of a plunger 14. Thereby, the plunger 14 axially drives the spool 4 through the shaft 11.

The spring 5 is a compressive coil spring, which urges the spool 4 toward the linear solenoid 2. The spring 5 is placed in a compressed state thereof in the spring chamber, which is located at the left side of the sleeve 3. One end of the spring 5 is in contact with a left surface of the spool 4, and the other end of the spring 5 is in contact with a bottom surface of an adjust screw 12, which closes the left end of the receiving hole 6 of the sleeve 3. The urging force of the spring 5 can be adjusted by adjusting an amount of thread engagement (an amount of threaded in) of the adjust screw 12.

The linear solenoid 2 includes the coil 13, the plunger 14, a magnetic stator 15 and a connector 16.

The coil 13 generates a magnetic force upon energization thereof to create a magnetic flux loop, which flows through the plunger 14 and the magnetic stator 15 The coil 13 is formed by winding a wire (enamel wire), which is coated with a dielectric film, around a bobbin 13a made of resin.

The plunger 14 is a generally cylindrical body made of magnetic metal (e.g., a ferromagnetic material, such as iron).

The plunger 14 directly slides along an inner peripheral surface of the magnetic stator 15 (more specifically, along an inner peripheral surface of a stator core 21, discussed latter).

Furthermore, as described above, the plunger 14 has the spool 4 side end surface that is in contact with the distal end of the shaft 11, so that the plunger 14 and the spool 4 are both urged toward the right side by the urging force of the spring 5 transmitted to the spool 4.

A breathing hole (or a breathing groove) 14a axially penetrates through the plunger 14.

The magnetic stator 15 includes a yoke 17 and a stator core 21. The yoke 17 is made of a magnetic material and is configured into a generally cup-shape body, which surrounds the outer peripheral surface of the coil 13. The stator core 21 is made of a magnetic material and includes a magnetically attracting core 18, a magnetically insulating portion 19 and a slidable core 20, which are integrally formed. The stator core 21 is inserted into the yoke 17 through a cup opening (left side) of the yoke 17, and the sleeve 3 and the stator core 21 are fixed together at the cup opening of the yoke 17.

The yoke 17 is made of the magnetic metal (e.g., a ferromagnetic material, such as iron) and surrounds the coil 13 to form a magnetic flux. After installing the components of the linear solenoid 2 into the yoke 17, the yoke 17 is securely coupled to the sleeve 3 by bending claw portions, which are formed at the end portion of the yoke 17, against the sleeve 3.

The magnetically attracting core 18 is made of magnetic metal (e.g., a ferromagnetic material, such as iron) and includes a flange portion 18a and an attracting portion 18b. The flange portion 18a is magnetically coupled to the opening end of the yoke 17. The attracting portion 18b is axially opposed to the plunger 14 and supports the shaft 11 in an axially slidable manner. A magnetically attracting portion (a main magnetic gap) is formed between the attracting portion 18b and the plunger 14. In the present embodiment, the attracting portion 18b is securely coupled to the inner peripheral surface of the flange portion 18a by a fixing technique, such as by press-fitting. Alternatively, the flange portion 18a and the attracting portion 18b may be formed integrally.

A breathing hole (or a breathing groove) is formed in the attracting portion 18b to axially penetrate through the attracting portion 18b.

A tubular recessed portion 18c, in which an end portion of the plunger 14 can be accommodated, is provided in a portion of the magnetically attracting core 18. The magnetically attracting core 18 and the portion of the plunger 14 axially intersect with each other. The outer peripheral surface of the tubular recessed portion 18c is tapered such that the magnetic attractive force does not change in response to the amount of stroke of the plunger 14.

The magnetically insulating portion 19 is a magnetically saturating portion, which limits the direct flow of the magnetic flux between the magnetically attracting core 18 and the slidable core 20. The magnetically insulating portion 19 is made of a thin wall portion, which has a relatively high magnetic resistance.

The slidable core 20 is made of magnetic metal (e.g., a ferromagnetic material, such as iron) and is configured into a cylindrical body, which covers generally the entire outer peripheral surface of the plunger 14. The slidable core 20 is received in a receiving recess 22, which is formed in a cup bottom of the yoke 17 (right side). The slidable core 20 is magnetically coupled to the yoke 17.

The plunger 14 directly slides along the inner peripheral surface of the slidable core 20, and the magnetic flux is radially transmitted between the slidable core 20 and the plunger 14. A magnetic exchange portion (a side magnetic gap) is formed between the slidable core 20 and the plunger 14.

The connector 16 is a connecting means for electrically connecting with an electronic control unit (not shown), which controls the solenoid hydraulic pressure control valve. Terminals 16a, which are connected to two ends, respectively, of the coil 31, are provided in an interior of the connector 16.

In the case of the linear solenoid 2 of the present embodiment where the plunger 14 directly slides along the inner peripheral surface of the stator core 21, a radial slide gap is present between the plunger 14 and the stator core 21. Thus, the center axis of the plunger 14 tends to deviate (to be biased) in the radial direction from the center axis of the sleeve 3 due to the application of the gravitational force and vibrations. In the biased state of the plunger 14, when the plunger 14 is magnetically attracted to the stator core 21 upon the energization of the coil 13, the magnetic flux tends to be biased at the time of conducting the magnetic flux between the plunger 14 and the stator core 21 in the radial direction. When such biasing of the magnetic flux occurs, a radial side force α is generated on the plunger 14 due to the biasing of the magnetic flux to interfere with the smooth slide movement between the plunger 14 and the stator core 21.

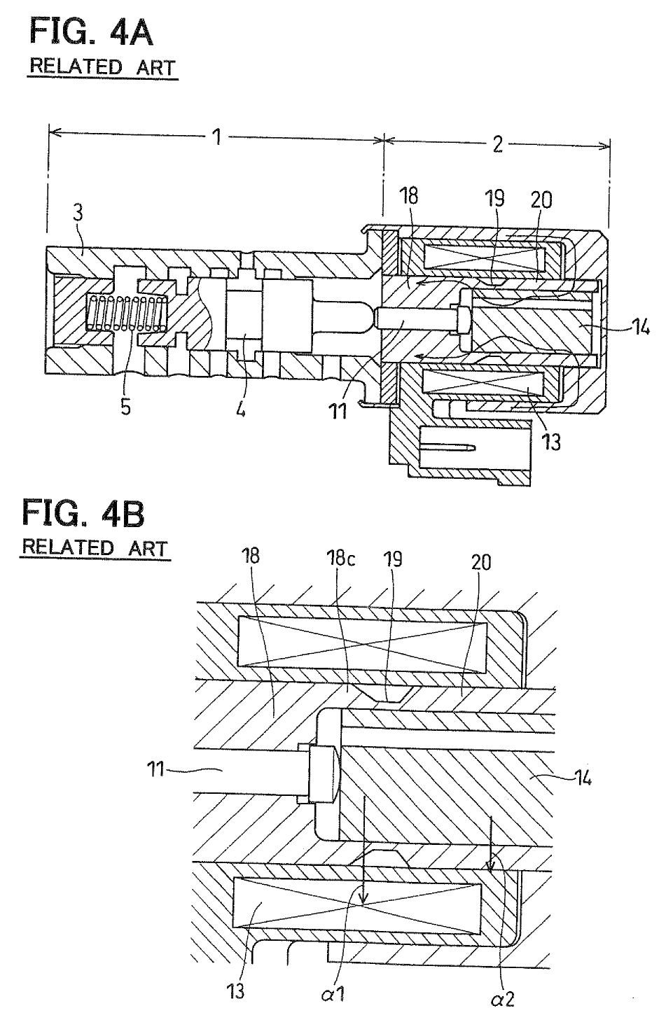

In order to address the above disadvantage, the magnetic flux is created to flow in the direction of an arrow shown in FIG. 4A upon the energization of the coil 13. As a result, the magnetic flux is relatively concentrated in the magnetically attracting portion in comparison to a magnetism passing portion, so that as shown in FIG. 4B, a radial side force α1 in the magnetically attracting portion becomes larger than a radial side force α2 in the magnetism passing portion.

The present embodiment focuses on the fact of that the radial side force α1 in the magnetically attracting portion is larger than the radial side force α2 in the magnetism passing portion. Specifically, the present embodiment adapts the technique of reducing the radial side force α1 in the magnetically attracting portion to reduce the entire radial side force α (the total side force) applied to the plunger 14.

Specifically, with reference to FIGS. 1A and 1B, the linear solenoid 2 of the first embodiment adapts the technique of forming a small diameter portion (reduced diameter portion) 14b, which has an outer diameter smaller than an outer diameter of a slidably contacting portion of the plunger 14 (i.e., the portion of the plunger 14, which slidably contacts the inner peripheral surface of the slide core 20). The small diameter portion 14b is formed at the axial end portion of the plunger 14, which enters in the tubular recessed portion 18c upon the slide movement of the plunger 14, as best seen in FIG. 1B. Specifically, the outer diameter φ1 of the end portion of the plunger 14, which enters in the tubular recessed portion 18c, is made smaller than the outer diameter φ2 of the slidably contacting portion of the plunger 14, which slidably contacts the inner peripheral surface of the slide core 20 (φ1<φ2). In FIGS. 1A and 1B, the components similar to those of FIG. 3 are indicated by the same reference numerals and will not be described further for the sake of simplicity.

The small diameter portion 14b is formed by processing the plunger 14 in a cutting process. An axial extent of the small diameter portion 14b (an extent of the portion of the plunger 14, which has the outer diameter φ1) is set to be equal to or larger than a maximum axial intersecting range, in which the plunger 14 and the tubular recessed portion 18c axially intersect with each other. That is, the small diameter portion 14b extends from the left end of the plunger 14 by the amount that is equal to or larger than the maximum axial intersecting range.

A center axis of the small diameter portion 14b (a center axis of the portion of the plunger 14, which has the outer diameter φ1) coincides with the center axis of the slidably contacting portion of the plunger 14 (a center axis of the portion of the plunger 14, which has the outer diameter φ2). In the axial view, a radial gap between the outer peripheral edge of the small diameter portion 14b and the outer peripheral edge of the slidably contacting portion of the plunger 14 is generally constant in the circumferential direction all around the plunger 14.

The diameter difference between the outer diameter φ1 of the small diameter portion 14b and the outer diameter φ2 of the slidably contacting portion of the plunger 14 only needs to be larger than 0 (zero) Here, the radial side force α1 in the magnetically attracting portion can be reduced by increasing this diameter difference.

However, when the diameter difference (φ2−φ1) between the outer diameter φ1 and the outer diameter φ2 becomes excessively large, the magnetic gap at the magnetically attracting portion at the time of deenergization of the coil 13 becomes large to deteriorate the initial response In view of the above point, the diameter difference between the outer diameter φ1 and the outer diameter φ2 is set to an appropriate value (specifically, the diameter difference being, for example, in a range of 50 μm to 0.5 mm).

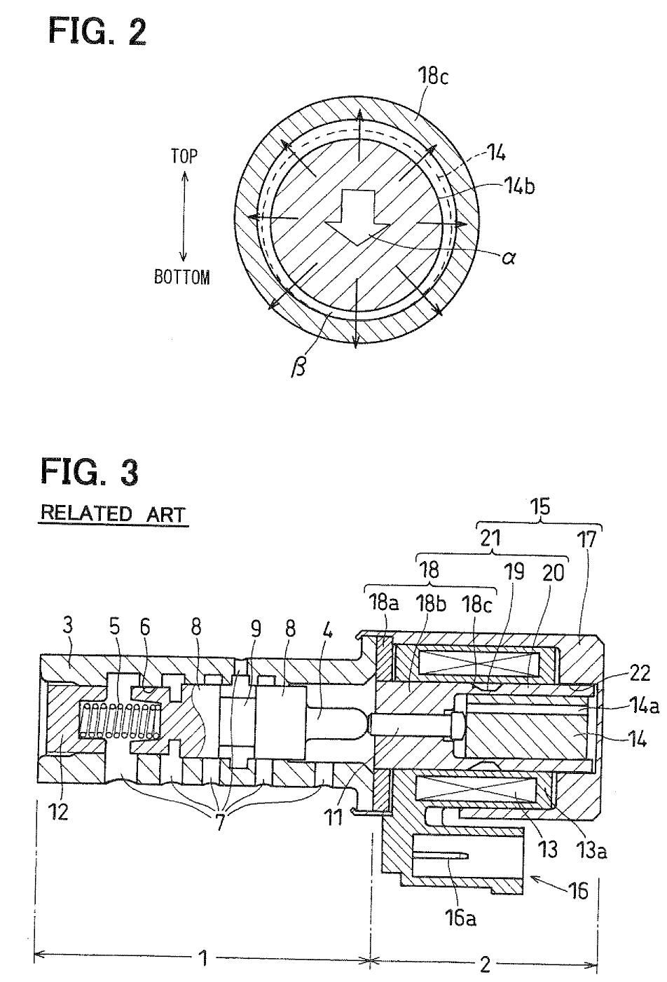

As discussed above, in the linear solenoid 2 of the first embodiment, the outer diameter φ1 of the portion of the plunger 14, which enters in the tubular recessed portion 18c, is set to be smaller than the outer diameter φ2 of the slidably contacting portion of the plunger 14. In this way, as shown in FIG. 2, even in the biased state where the center axis of the plunger 14 is biased relative to the center axis of the stator core 21, the radial gap β between the plunger 14 and the tubular recessed portion 18c at the magnetically attracting portion can be increased, and thereby the radial attractive force of the plunger 14 at the magnetically attracting portion can be made small.

As described above, when the radial side force α1 in the magnetically attracting portion is made small, the entire radial side force α (the total side force) applied to the plunger 14 can be reduced in comparison to the previously proposed technique. Thereby, the smooth slide movement of the plunger 14 can be achieved.

Thus, the radial side force α (the total side force) of the plunger 14 can be reduced without a need for additionally forming a non-magnetic layer 14c (see the second embodiment described latter) on the slidable surface of the plunger 14. Thus, the smooth slide movement of the plunger 14 is achieved while limiting an increase in the costs, which would be otherwise caused by the formation of the non-magnetic layer 14c.

### Second Embodiment

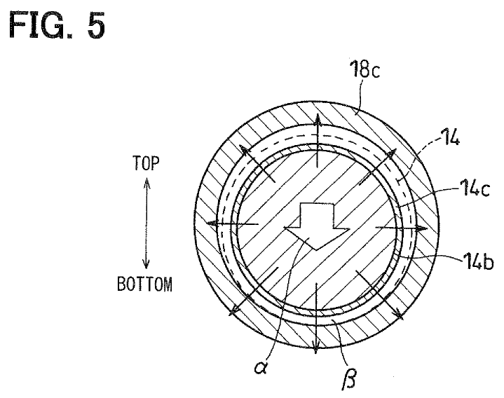

A second embodiment of the present invention will be described with reference to FIG. 5. In the following embodiments, components similar to those of the first embodiment will be indicated by the same reference numerals.

In the second embodiment, in addition to the technique of the first embodiment described above, the non-magnetic layer 14c, which is made of the non-magnetic material, is formed on the slidable surface of the plunger 14 (at least one of the outer peripheral surface of the plunger 14 and the inner peripheral surface of the stator core 21).

Specifically, in the second embodiment, the non-magnetic layer 14c, which is made of the non-magnetic material (e.g., nickel zinc plating), is formed on the outer peripheral surface of the plunger 14.

Even in this case where the non-magnetic layer 14c is formed on the outer peripheral surface of the plunger 14, the outer diameter φ1 of the magnetic material of the portion of the plunger 14, which enters in the tubular recessed portion 18c, is set to be smaller than the outer diameter φ2 of the magnetic material of the slidably contacting portion of the plunger 14, which slidably contacts the inner peripheral surface of the slidable core 20, like in the first embodiment. In this way, the thickness of the non-magnetic layer 14c and the gap β are radially provided between the plunger 14 and the tubular recessed portion 18c, and the radial side force α1, which is generated in the magnetically attracting portion, can be further reduced.

That is, even in the case where the non-magnetic layer 14c is formed in the slidable surface of the plunger 14, the entire radial side force α (the total side force) applied to the plunger 14 can be further limited, and thereby the smooth slidability of the plunger 14 can be further enhanced.

### Third Embodiment

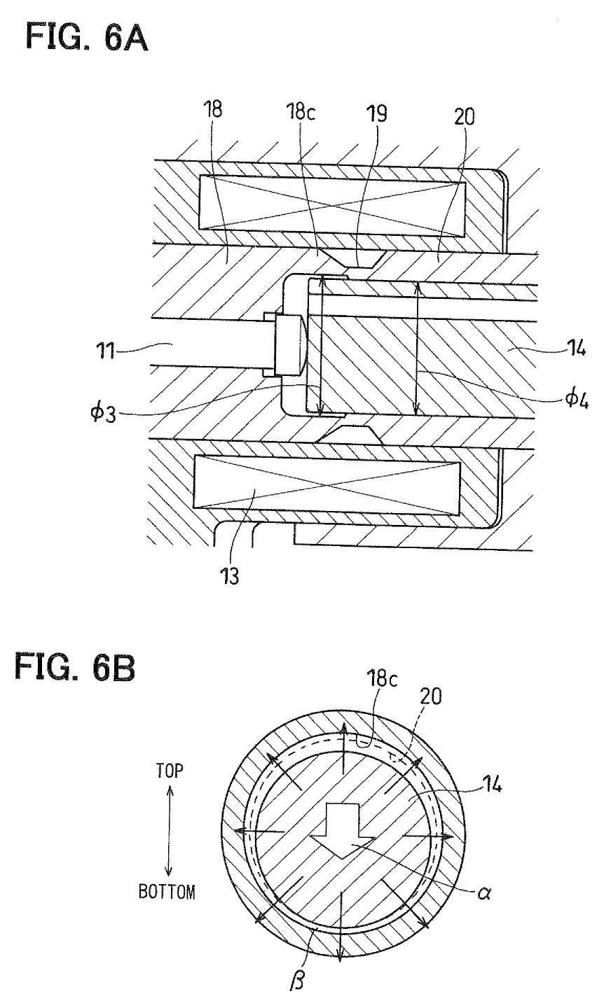

A third embodiment of the present invention will be described with reference to FIGS. 6A and 6B.

In the first embodiment, the outer diameter of the portion of the plunger 14, which enters in the tubular recessed portion 18c, is reduced to increase the radial gap β between the plunger 14 and the tubular recessed portion 18c at the magnetically attracting portion.

In contrast, according to the third embodiment, the inner diameter of the tubular recessed portion 18c, in which the plunger 14 enters, is increased to increase the radial gap β between the plunger 14 and the tubular recessed portion 18c at the magnetically attracting portion.

Specifically, in the third embodiment, as shown in FIG. 6A, the inner diameter φ3 of the tubular recessed portion 18c is increased relative to the inner diameter φ4 of the slidably contacting portion (slidably contacting inner peripheral surface) of the slidable core 20, to which the plunger 14 slidably contacts.

The increasing of the inner diameter of the tubular recessed portion 18c is implemented by, for example, processing the portion of the inner peripheral part of the stator core 21 in a cutting process. An axial extent of the portion (the tubular recessed portion 18c), which has the inner diameter φ3, is set to be equal to or larger than the maximum axial intersecting range, in which the plunger 14 and the tubular recessed portion 18c axially intersect with each other.

Even in this case, the radial gap β between the plunger 14 and the tubular recessed portion 18c at the magnetically attracting portion can be increased to achieve the advantages similar to those of the first embodiment.

### Fourth Embodiment

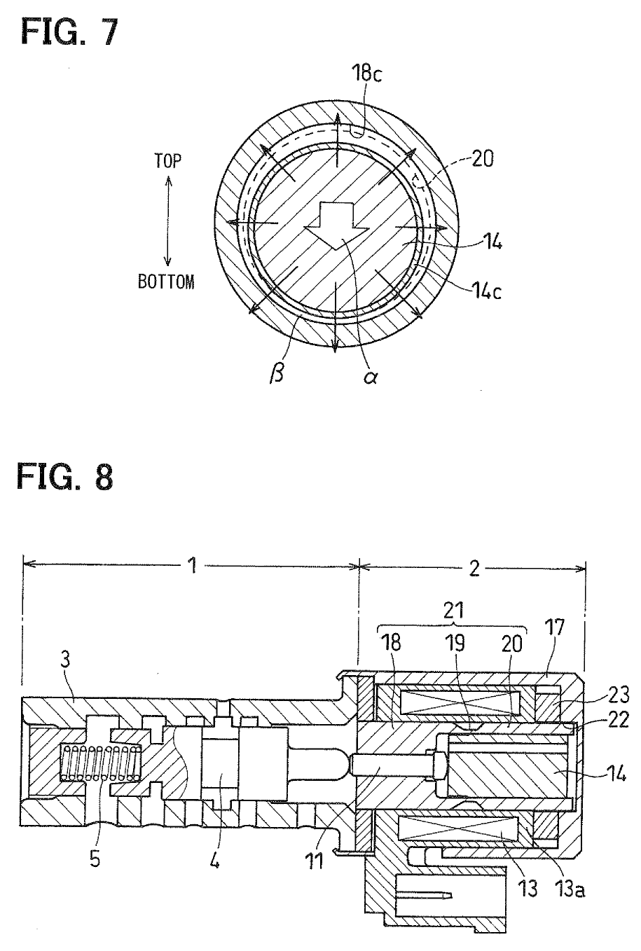

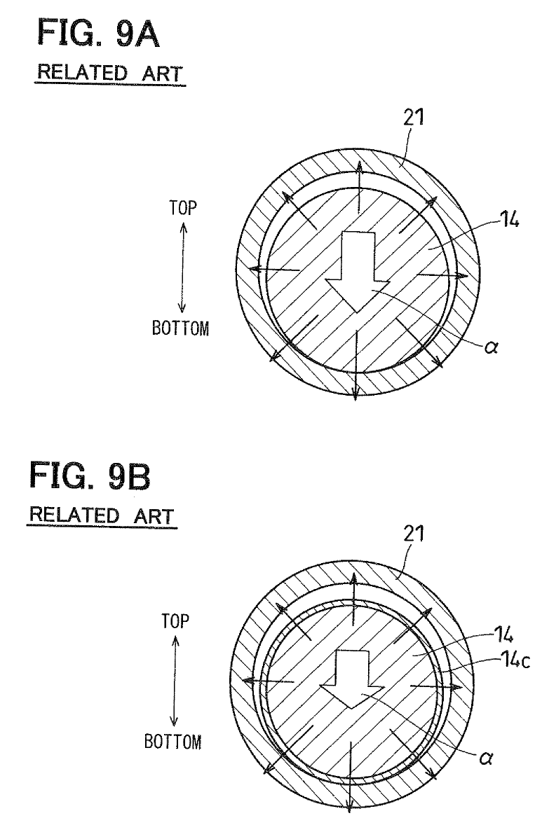

A fourth embodiment of the present invention will be described with reference to FIG. 7.

In the fourth embodiment, in addition to the technique of the third embodiment described above, the non-magnetic layer 14c, which is made of the non-magnetic material, is formed on the slidable surface of the plunger 14 (at least one of the outer peripheral surface of the plunger 14 and the inner peripheral surface of the stator core 21).

Specifically, in the fourth embodiment, the non-magnetic layer 14c, which is made of the non-magnetic material (e.g., nickel zinc plating), is formed on the outer peripheral surface of the plunger 14.

Even in this case where the non-magnetic layer 14c is formed on the outer peripheral surface of the plunger 14, the inner diameter φ3 of magnetic material of the tubular recessed portion 18c is set to be larger than the inner diameter φ4 of the magnetic material of the slidably contacting portion of the slidable core 20, which slidably contacts the plunger 14, like in the third embodiment. In this way, the thickness of the non-magnetic layer 14c and the gap p are radially provided between the plunger 14 and the tubular recessed portion 18c, and the radial side force α1, which is generated in the magnetically attracting portion, can be further reduced to further enhance the slidability of the plunger 14.

### Fifth Embodiment

A fifth embodiment of the present invention will be described with reference to FIG. 8.

In the linear solenoid 2 of each of the first to fourth embodiments, the stator core 21 is inserted through the cup opening of the yoke 17 and is fixed at the cup opening of the yoke 17 against the sleeve 3 while the distal end portion (at the right side in the drawings) of the slidable core 20, which is spaced from the cup opening of the yoke 17, is unfixed.

When the slidable core 20 is installed into the receiving recess 22, which is formed in the cup bottom of the yoke 17, in the state where the distal end portion of the slidable core 20, is unfixed, the distal end portion of the slidable core 20 may possibly hit the receiving recess 22 at the time of installation to cause deformation of the slidable core 20 due to the product-to-product variations of the stator core 21 or misalignment of the axis of the stator core 20 relative to the axis of the yoke 17. When the deformation occurs in the slidable core 20, the slidability of the plunger 14, which directly slides along the inner peripheral surface of the slidable core 20 may possibly be deteriorated.

In view of the above point, it is required to provide a sufficient installation gap between the distal end portion of the slidable core 20 (the free end portion of the stator core 21) and the receiving recess 22 to absorb the product-to-product variations of the stator core 21 or the misalignment of the axis of the stator core 20 relative to the axis of the yoke 17.

However, the magnetic circuit is formed through the installation gap. Thus, when the installation gap is increased, the magnetic transmission efficiency is reduced to disadvantageously reduce the magnetic attracting performance of the plunger 14.

In view of the above point, the following technique is adapted in the fifth embodiment in addition to the structure of one of the first to fourth embodiments.

In the linear solenoid 2 of the fifth embodiment, a ring core 23, which is made of a magnetic material (e.g., a ferromagnetic material, such as iron), is provided to the distal end portion of the slidable core 20 (the unfixed side end portion of the stator core 21). The ring core 23 covers the outer peripheral surface of the slidable core 20 to conduct the magnetic flux relative to the slidable core 20 in the radial direction. Also, the ring core 23 contacts the cup bottom of the yoke 17 to conduct the magnetic flux relative to the yoke 17 in the axial direction.

The ring core 23 is configured into an annular plate (ring plate) form, which has a predetermined plate thickness. The ring core 23 is axially placed between the bobbin 13a and the cup bottom of the yoke 17. The inner peripheral surface of the ring core 23 is a cylindrical surface, which is parallel to the outer peripheral surface of the slidable core 20 while a minute clearance (installation clearance) is interposed therebetween. The inner peripheral surface of the ring core 23 is axially slidable over the outer peripheral surface of the slidable core 20.

Here, the plate thickness of the ring core 23 is set to be slightly smaller than the axial gap between the bobbin 13a and the cup bottom of the yoke 17 to avoid interference at the time of fixing the stator core 21 to the yoke 17. Even in this way, when the magnetic flux is generated upon the energization of the coil 13, the ring core 23 is attracted to and thereby contacts the adjacent cup bottom of the yoke 17.

A radial gap is provided between the outer peripheral surface of the ring core 23 and the inner peripheral surface of the yoke 17, so that the ring core 23 can be displaced in the radial direction upon occurrence of radial displacement of the distal end portion of the slidable core 20.

In the linear solenoid 2 of the fifth embodiment, the above described structure of the fifth embodiment is adapted in addition to the structure of the one of the first to fourth embodiments. Thus, even when the installation gap is present between the free end portion of the slidable core 20 and the adjacent receiving recess 22 of the yoke 17, the free end portion of the slidable core 20 and the cup bottom of the yoke 17 are magnetically coupled with each other though the ring core 23. Therefore, it is possible to substantially eliminate the reduction in the magnetic flux caused by the installation gap.

That is, even in the structure where the installation gap is present between the free end portion of the slidable core 20 and the adjacent yoke 17, the reduction of the magnetic flux can be substantially eliminated by the ring core 23. Therefore, the high performance of the linear solenoid 2 can be maintained, and thereby the high performance of the solenoid hydraulic pressure control valve can be maintained.

Furthermore, in the structure where the stator core 21 is fixed only at the cup opening of the yoke 17 while the distal end portion of the stator core 21 (the right end portion of the slidable core 20) is unfixed, it is possible to provide the sufficient installation gap between the free end portion of the slidable core 20 and the adjacent receiving recess 22 of the yoke 17 to absorb the product-to-product variations of the stator core 21 and the misalignment of the axis of the stator core 20 relative to the axis of the yoke 17. Therefore, it is possible to reliably limit the deformation of the slidable core 20 at the time of installation, and it is possible to limit occurrence of the sliding malfunction of the plunger 14, which would be caused by the deformation of the slidable core 20.

In the above embodiments, the present invention is applied to the solenoid hydraulic pressure control valve used in the hydraulic pressure control device of the automatic transmission. Alternatively, the present invention may be applied to a solenoid hydraulic pressure control valve of any other device, which is other than the automatic transmission. Furthermore, the present invention may be applied to a solenoid valve(s) other than the solenoid hydraulic pressure control valve(s).

In the above embodiment, the present invention is applied to the linear solenoid 2, which drives the valve (the spool valve 1 in the above embodiments). Alternatively, the present invention may be applied to the linear solenoid 2, which directly or indirectly drives a driven element other than the valve.

Additional advantages and modifications will readily occur to those skilled in the art. The invention in its broader terms is therefore not limited to the specific details, representative apparatus, and illustrative examples shown and described.

What is claimed is:

1. A linear solenoid comprising:
a stator core that is made of a magnetic material and includes a magnetically attracting core, a magnetically insulating portion and a slidable core, which are formed integrally; and
a plunger that is made of a magnetic material and is directly slidable along an inner peripheral surface of the slidable core, wherein:
a tubular recessed portion is formed in the magnetically attracting core;
the plunger is axially intersectable with the tubular recessed portion upon slide movement of the plunger, which places a predetermined portion of the plunger into the tubular recessed portion; and
the magnetic material in the predetermined portion of the plunger has a predetermined outer diameter that is smaller than an outer diameter of the magnetic material in a slidably contacting portion of the plunger, which slidably contacts the slidable core.

2. The linear solenoid according to claim 1, wherein a non-magnetic layer, which is made of a non-magnetic material, is formed in at least one of an outer peripheral surface of the plunger and an inner peripheral surface of the stator core.

3. The linear solenoid according to claim 1, further comprising:
a coil that generates a magnetic force upon energization of the coil; and
a yoke that is made of a magnetic material and is configured into a cup-shape body that covers an outer peripheral surface of the coil, wherein:
a fixing portion of the stator core is fixed at a cup opening of the yoke upon installation of the stator core into the yoke through the cup opening of the yoke;
a ring core, which is made of a magnetic material, covers a distal end portion of the slidable core, which is spaced from the fixing portion of the stator core; and
the ring core conducts a magnetic flux relative to the slidable core in a radial direction and also conducts a magnetic flux relative to a cup bottom of the yoke in an axial direction.

4. The linear solenoid according to claim 1, wherein an axial extent of the magnetic material, which has the predetermined outer diameter, in the predetermined portion of the plunger is equal to or larger than a maximum axial intersecting range between the plunger and the tubular recessed portion.

5. A linear solenoid comprising:
a stator core that is made of a magnetic material and includes a magnetically attracting core, a magnetically insulating portion and a slidable core, which are formed integrally; and
a plunger that is made of a magnetic material and is directly slidable along an inner peripheral surface of the slidable core, wherein:
a tubular recessed portion is formed in the magnetically attracting core;
the plunger is axially intersectable with the tubular recessed portion upon slide movement of the plunger, which places a predetermined portion of the plunger into the tubular recessed portion; and
the magnetic material in the tubular recessed portion has a predetermined inner diameter that is larger than an inner diameter of the magnetic material in a slidably contacting portion of the slidable core, which slidably contacts the plunger.

6. The linear solenoid according to claim 5, wherein a non-magnetic layer, which is made of a non-magnetic material, is formed in at least one of an outer peripheral surface of the plunger and an inner peripheral surface of the stator core.

7. The linear solenoid according to claim 5, further comprising:
a coil that generates a magnetic force upon energization of the coil; and
a yoke that is made of a magnetic material and is configured into a cup-shape body that covers an outer peripheral surface of the coil, wherein:
a fixing portion of the stator core is fixed at a cup opening of the yoke upon installation of the stator core into the yoke through the cup opening of the yoke; and
a ring core, which is made of a magnetic material, covers a distal end portion of the slidable core, which is spaced from the fixing portion of the stator core; and
the ring core conducts a magnetic flux relative to the slidable core in a radial direction and also conducts a magnetic flux relative to a cup bottom of the yoke in an axial direction.

8. The linear solenoid according to claim 5, wherein an axial extent of the magnetic material, which has the predetermined inner diameter, in the tubular recessed portion is equal to or larger than a maximum axial intersecting range between the plunger and the tubular recessed portion.
